(19) United States
(12) Patent Application Publication
(10) Pub. No.: US 2006/0112844 A1
(43) Pub. Date: Jun. 1, 2006

(54) Method for producing flexoprinting forms by means of laser engraving using photopolymer flexoprinting elements and photopolymerisable flexoprinting element

(76) Inventors: Margit Hiller, Karlstadt (DE); Jens Schadebrodt, Mainz (DE); Wolfgang Wenzl, Mannheim (DE)

Correspondence Address: CONNOLLY BOVE LODGE & HUTZ, LLP, P O BOX 2207, WILMINGTON, DE, 19899, US

(21) Appl. No.: 10/538,753

(22) PCT Filed: Dec. 5, 2003
(86) PCT No.: PCT/EP03/13743

§ 371 Date: Jun. 10, 2005

(30) Foreign Application Priority Data
Dec. 13, 2002 (DE) 102 58 668

(51) Int. Cl. B41N 3/00

(52) U.S. Cl. 101/463.1

(57) ABSTRACT

Flexographic printing plates are produced by means of direct laser engraving using photopolymerizable flexographic printing elements as a starting material by a process in which the crosslinking of the photopolymerizable flexographic printing element with actinic light is effected through a protective element substantially transparent to actinic light.

The present invention relates to a process for the production of flexographic printing plates by means of direct laser engraving using photopolymerizable flexographic printing elements as starting materials, the crosslinking of the photopolymerizable flexographic printing element being effected with actinic light through a protective element substantially transparent to actinic light.

In direct laser engraving for the production of flexographic printing plates, a printing relief is engraved directly into the relief-forming layer of a flexographic printing element by means of a laser. A subsequent development step as in conventional processes for the production of flexographic printing plates is no longer required. Typical relief layer thicknesses of flexographic printing plates are from 0.5 to 7 mm, in the case of special thin-layer plates also only 0.2 mm in certain circumstances. The nonprinting wells in the relief are at least 0.03 mm in the screen area, or substantially more in the case of other negative elements, and may assume values of up to 3 mm in the case of thick plates. Thus, large amounts of material have to be removed by means of the laser. Direct laser engraving therefore differs very substantially in this respect from other techniques known from the printing plate sector, in which lasers are used only for writing on a mask, but the actual production of the printing plate is still effected by means of a washout and development process.

Various starting materials and processes for laser engraving which are particularly adapted for the production of flexographic printing plates by laser engraving have been proposed, for example by U.S. Pat. No. 3,549,733, EP-A 640 043, EP-A 640 044, EP-A 710 573, EP-A 1 080 883 or EP-A 1 136 254.

U.S. Pat. No. 5,259,311 has proposed using commercial photopolymerizable flexographic printing elements as starting material for the production of flexographic printing plates by means of laser engraving.

Commercial photopolymerizable flexographic printing elements comprise a dimensionally stable substrate, usually of PET film, a relief-forming layer applied thereon and comprising an elastomeric binder, ethylenically unsaturated monomers and a photoinitiator or photoinitiator system, a substrate layer and a PET cover sheet. The substrate layer is also known as a release layer. For the conventional, photochemical production of a flexographic printing plate, the protective film is peeled off. The substrate layer adheres more firmly to the photopolymerizable layer than to the protective film and thus remains on the photopolymerizable layer. A photographic mask is then placed on the substrate layer and exposure to actinic light is effected through this mask. The exposure is usually effected by means of a vacuum frame or a vacuum film. The reduced pressure ensures particularly intimate contact between the photographic mask and the flexographic printing element, and moreover the diffusion of oxygen into the photopolymerizable layer is prevented or at least made more difficult. The object of the substrate layer is to ensure that the protective film can be peeled off the flexographic printing element, and that moreover the photographic mask can be placed on the flexographic printing element for exposure to light and then removed again without the mask remaining adhesively bonded to the photopolymerizable layer or adhering so strongly that the surface of the relief-forming layer is damaged when the mask is peeled off. After the exposure, the substrate layer and the unexposed parts of the photopolymerizable layer are removed by means of a washout agent.

In the laser engraving process proposed by U.S. Pat. No. 5,259,311, the PET protective film of the conventional flexographic printing element is first peeled off, the substrate layer remaining on the photopolymerizable layer. The relief-forming layer is then photochemically crosslinked in the total volume by exposure to actinic light, through the substrate layer. Finally, the substrate layer is removed by means of an organic flexographic washout agent and the plate is dried. In a further step, a printing relief is engraved into the relief-forming layer by means of a CO₂ laser. The end of the disclosed process comprises a further cleaning step with a flexographic washout agent. The plate must then be dried again.

The process disclosed has a number of disadvantages. The organic solvent used for removing the substrate layer does not dissolve the crosslinked relief-forming layer but the layer nevertheless swells therein, the layer thickness increasing. Disadvantageously, however, solvent residues in the relief-forming layer reduce the quality of the print relief obtained by laser engraving. The flexographic printing element must therefore be very thoroughly dried in order also to remove solvent residues very completely. Very good drying is also required for a second reason: in the laser engraving, the focus of the laser should preferably be at the surface of the relief layer. If an incompletely dried plate is used, it does of course continue to release solvent through evaporation in the course of time. This means that its thickness decreases. If the focus of the laser was still at the surface at the beginning of the engraving of a flexographic printing element, it is located above it with increasing duration of engraving. This leads to a different engraving result and accordingly the flexographic printing element is not engraved uniformly over the total area, which leads to a poorer printed image.

The dual washing and drying step is thus very time-consuming. The time benefit of the direct laser engraving compared with the conventional process is thus lost again and, in unfavorable cases, the process even takes longer.

If the release layer is not removed, in order to avoid the treatment with solvent and the associated disadvantages, melt edges form around the engraved layer elements. Such melt edges consist of residues of the relief-forming layer and residues of the substrate layer. The melt edges interfere with the printed image. Of course, this effect is all the more pronounced the finer the elements of the relief layer which are to be engraved and the more material which is ablated. This procedure is thus also not possible if it is wished to provide high-resolution plates by means of laser engraving.

The use of conventional photopolymerizable flexographic printing elements for the production of flexographic printing plates by means of laser engraving is thus associated with problems. This implies the use of special flexographic printing elements particularly adapted to the requirements of laser engraving. However, the use of conventional photopolymerizable flexographic printing elements is in principle attractive since they can be produced particularly elegantly, with high precision and economically by extrusion. Moreover, their properties important for the printing process, such as ink transfer, flexibility and mechanical properties, are ensured.

It is an object of the present invention to provide an improved process for the production of flexographic printing plates by means of laser engraving and starting materials suitable for this purpose, which process does not have the disadvantages of the prior art.

We have found that this object is achieved by a process for the production of flexographic printing plates by means of laser engraving, in which the starting material used is a photopolymerizable flexographic printing element at least comprising, arranged one on top of the other,
a dimensionally stable substrate,
a photopolymerizable, relief-forming layer having a thickness of at least 0.3 mm, at least comprising an elastomeric binder, an ethylenically unsaturated monomer and a photoinitiator, and
a protective element substantially transparent to actinic light, wherein the process comprises—in this sequence—the following steps:
(a) crosslinking of the relief-forming layer in the total volume of the layer by exposure to actinic light through the protective element,
(b) removal of the protective element and
(c) engraving of a print relief into the crosslinked relief-forming layer with the aid of a laser emitting from 3 000 to 12 000 nm, the height of the relief elements to be engraved with the laser being at least 0.03 mm,
   and the protective element is a film which has been provided with a nontacky treatment or coating on the side facing the relief-forming layer and which is applied directly to the relief-forming layer, the adhesion between the protective element and the relief-forming layer being adjusted so that the protective element can be peeled off the crosslinked, relief-forming layer after process step (a).

We have furthermore found a photopolymerizable flexographic printing element which comprises, arranged one on top of the other, at least
a dimensionally stable substrate,
a photopolymerizable, relief-forming layer having a thickness of at least 0.3 mm, at least comprising an elastomeric binder, an ethylenically unsaturated monomer and a photoinitiator, and
a protective element substantially transparent to actinic light,
   the protective element being a film which has been provided with a nontacky treatment or coating on the side facing the relief-forming layer and which is applied directly to the relief-forming layer, and the adhesion between the protective element and the relief-forming layer being adjusted so that the protective element can be peeled off the crosslinked relief-forming layer after exposure to actinic light through the protective element.

Surprisingly, it has been found that substantially better results can be achieved by replacing the release layer and cover sheet of conventional flexographic printing elements by the novel protective element and changing process steps compared with known laser engraving processes.

Regarding the invention, the following may be stated specifically:

Suitable dimensionally stable substrates for the starting material used according to the invention are in particular polymer films, for example comprising PET or PEN, or metal sheets, for example comprising aluminum or steel.

Furthermore, the photopolymerizable flexographic printing element comprises at least one photopolymerizable relief-forming layer, at least comprising an elastomeric binder, an ethylenically unsaturated monomer, a photoinitiator and optionally further additives. The relief-forming layer may be applied directly to the substrate. However, other layers, for example adhesion promoting layers and/or resilient lower layers, may also be present between the substrate and the relief-forming layer.

The components of the relief-forming layer may be the components usually used for the production of conventional flexographic printing plates. A person skilled in the art makes a suitable choice from them according to the desired properties of the layer. Examples of suitable elastomeric binders include natural rubber, polybutadiene, polyisoprene, styrene/butadiene rubber, nitrile/butadiene rubber, butyl rubber, styrene/isoprene rubber, polynorbornene rubber or ethylene/propylene/diene rubber (EPDM). Further examples include thermoplastic elastomeric block copolymers of the styrene/butadiene or styrene/isoprene type.

Particularly suitable ethylenically unsaturated monomers are esters or amides of (meth)acrylic acid with mono- or polyfunctional alcohols, amines, amino alcohols or hydroxyethers and hydroxyesters. Examples include butyl acrylate, 2-ethylhexyl acrylate, lauryl acrylate, 1,4-butanediol diacrylate and 1,6-hexanediol diacrylate.

It is known that suitable initiators for the photopolymerization are benzoin and benzoin derivatives, benzil derivatives, acylphosphine oxides and acylarylphosphinic esters, without there being any intention to restrict the list to these.

Mixtures of a plurality of binders, of a plurality of monomers or a plurality of photoinitiators can of course also be used, provided that the properties of the relief-forming layer are not adversely affected thereby.

The relief-forming layer may furthermore optionally comprise additives and assistants which are in principle known, for example plasticizers, dyes, dispersants or antistatic agents. They are chosen by a person skilled in the art according to the desired properties of the layer. In making the choice, a person skilled in the art is aware that the term “photopolymerizable” requires that actinic light can penetrate in sufficient intensity into the photopolymerizable layer, and there are therefore limits with regard to the addition of absorbing and/or scattering additives.

The photopolymerizable, relief-forming layer may also be composed of a plurality of part-layers. These crosslinkable part-layers may be of the same, roughly the same or different composition.

The thickness of the relief-forming layer or of all relief-forming part-layers together is at least 0.3 mm and usually not more than 7 mm. The thickness is preferably from 0.5 to 3.5 mm, particularly preferably from 0.7 to 2.9 mm.

According to the invention, a protective element is applied directly to the relief-forming layer. The protective element is substantially transparent to actinic light, i.e. it should be transparent to actinic light to a degree such that the photopolymerization of the relief-forming layer is possible without impairment of quality. The term transparent does not rule out the fact that the protective element can absorb or scatter actinic light to a limited extent, i.e. without adversely affecting the crosslinking. For example, it is entirely possible for it to be hazy.

The protective element is a film which has been provided with a nontacky treatment or coating on the side facing the relief-forming layer. It is applied directly to the relief-forming layer.

The film is usually a polymeric film, for example a film comprising polyethylene or polypropylene, PET, PEN or polyamide. It may also be a laminated film comprising a plurality of different polymeric materials. It is preferably a PET film. The film is provided with a nontacky treatment or is coated with a nontacky layer.

“Can be peeled off” is to be understood as meaning that the entire protective element can be easily removed from the crosslinked, relief-forming layer so that the surface of the relief-forming layer is not damaged thereby and that no residues of the protective element remain on the relief-forming layer. The adhesion should, on the other hand, be sufficiently high, both before and after exposure, that the protective element is securely connected to the relief-forming layer in order to fulfill the purpose of protection.

The adhesion between the relief-forming layer and the protective element is adjusted so that the protective element can be completely peeled off the now crosslinked relief-forming layer after exposure to actinic light in process step (a). A protective element which can be peeled off the uncrosslinked, relief-forming layer before exposure but cannot or at least can no longer be completely peeled off after exposure is not suitable for carrying out the present invention. On the other hand, a protective element which cannot be peeled off before exposure but only after exposure is suitable for carrying out the present invention.

Both the surface properties of the relief-forming layer and that side of the protective element which faces the relief-forming layer are important for establishing the adhesion. According to the invention, the surface properties of the two layers should be tailored to one another so that the desired peelability after exposure in process step (a) is obtained. In this context, it is self-evident to a person skilled in the art that not every combination of protective elements with relief-forming layers leads to the desired result. A protective element which can be peeled off a relief-forming layer of a certain composition need not necessarily be capable of being peeled off a relief-forming layer of another composition.

The surface of the film of the protective element is provided with a nontacky treatment or coated with a nontacky layer on the side facing the relief-forming layer.

A nontacky treatment may be, for example, a siliconization or Teflonization of the film.

Polymeric materials are particularly suitable for the production of a nontacky layer. Said layer can be produced, for example, by dissolving the polymer and casting on the film, followed by evaporation of the solvent. For example, it may be a polyamide.

With the use of nontacky layers, there must be a reliably reproducible difference in adhesion between the nontacky layer and the film on the one hand and the nontacky layer and the relief-forming layer on the other hand, so that the nontacky layer adheres more strongly to the film than to the relief-forming layer, and the reliable peelability of the protective film is ensured without the surface quality of the flexographic printing element being impaired as a result of peeling off. An adhesion-promoting layer which enhances the adhesion between nontacky layer and film can therefore optionally be present between the nontacky layer and the protective film. In a further embodiment, the surface of the film can be modified in order to achieve stronger adhesion, for example by introducing inorganic particles into the surface. In a third embodiment, the film can be subjected to a corona treatment before application of the nontacky layer, by means of which treatment the adhesion of the nontacky layer to the film is improved. Details of a corona treatment are disclosed, for example, in DE-A 197 11 696.

The surface properties of the relief-forming layer can be influenced by the choice of the components of the relief-forming layer and the amount thereof.

For obtaining the desired delamination properties after exposure, it has proven useful to employ thermoplastic elastomeric block copolymers of the styrene/butadiene type as an elastomeric binder in the relief-forming layer.

The block copolymers may be two-block copolymers, three-block copolymers or multiblock copolymers, in which in each case a plurality of styrene and butadiene blocks follow one another alternately in succession. They may be linear, branched or star block copolymers. The block copolymers used according to the invention are particularly preferably styrene/butadiene/styrene three-block copolymers. The styrene content of the styrene/butadiene block copolymer used is usually from 20 to 40, preferably from 25 to 35, % by weight, based on the binder. Such SBS block copolymers are commercially available, for example under the name Kraton®, it being necessary to take into account that commercial three-block copolymers usually contain a certain proportion of two-block copolymers. Of course, mixtures of different SBS block copolymers may also be used.

A particularly advantageous combination for carrying out the invention arises through the use of styrene/butadiene block copolymers in the relief-forming layer and through the use of a protective element which has a nontacky layer which comprises polyamide.

The flexographic printing element can be produced, for example, by dissolving or dispersing all components in a suitable solvent and casting on the dimensionally-stable substrate. In the case of multilayer elements, a plurality of layers can be cast one on top of the other in a manner known in principle. After the casting, the protective element is applied. Conversely, it is also possible to cast onto the protective element and finally to laminate the substrate with it.

If thermoplastic elastomeric binders are used, the production of the relief layer can particularly advantageously be effected in a manner known in principle, by melt extrusion between a dimensionally stable substrate film and the protective element and calendering of the laminate obtained, as disclosed, for example, in EP-A 084 851. Multilayer elements can be produced by means of coextrusion. Flexographic printing elements having metallic substrates can preferably be obtained by casting or extruding onto a temporary substrate and then laminating the layer with the metallic substrate. It is also possible to cast onto the protective element and then to laminate the metallic substrate with it.

The photochemically crosslinkable flexographic printing element described is used as a starting material for the novel process.

In step (a) of the novel process, the relief-forming layer is photochemically crosslinked in the total volume of the layer by exposure to actinic light. The exposure is effected here from the top of the flexographic printing element through the protective element substantially transparent to actinic radiation.

In addition to the exposure through the protective element, optionally preexposure from the back may also be carried out. The latter does of course require that the dimensionally stable substrate be transparent to actinic radiation. Preexposure from the back is therefore not possible, for example, in the case of metallic substrates. If exposure from the back is carried out, it can be effected before, after or simultaneously with the exposure from the front of the plate. Exposure from the back is preferably carried out beforehand.

Process step (a) can be carried out in the presence or absence of atmospheric oxygen. The presence of reduced pressure as in the case of conventional flexographic printing elements is not required. The protective element protects the relief-forming layer so effectively from oxygen that inhibiting oxygen cannot diffuse into it to a substantial extent, and the uppermost sections of the relief-forming layer are also polymerized to a sufficient extent in order to obtain a print relief of adequate quality. UV-A radiation having a wavelength of from about 320 to 400 nm and/or UV-A/VIS radiation having a wavelength of from about 320 to about 700 nm are particularly suitable as actinic light.

After process step (a), the protective element is removed or peeled off in its totality in process step (b).

In a preferred embodiment, the crosslinked relief-forming layer is optionally crosslinked in a process step (b′) following step (b) to a limited depth of penetration, viewed from the surface, beyond the extent of the crosslinking density produced by step (a).

If step (b′) is provided, not all ethylenically unsaturated groups in the layer are reacted with the formation of a polymeric network in the course of the crosslinking in process step (a), but the crosslinking is carried out so that unconverted groups remain. The incomplete conversion can be achieved, for example, by limiting the exposure time.

Only parts of the relief-forming layer are affected by the crosslinking step (b′), which has only a superficial effect. No further crosslinking takes place in the total volume of the layer but only in a partial volume of the layer. The effectiveness of the crosslinking step (b′) results in a limited depth of penetration, viewed from the surface of the relief-forming layer, so that the uppermost zone of the layer is crosslinked to a greater extent than would be the case with the exclusive use of process step (a). Some or all of the crosslinkable groups which are not converted in process step (a) are converted here.

The width of the zone within which the crosslinking density is increased by step (b′), or the effective depth of penetration of the measure taken for crosslinking, is as a rule at least 5 μm and not more than 200 μm, viewed from the surface of the recording layer, without it being intended to limit the width thereto. The depth of penetration is preferably 5-150 μm, particularly preferably 5-100 μm. The transition from the zone whose crosslinking density is increased in the course of step (b′) beyond the level of process step (a) to the zone which is not affected by process step (b′) may be abrupt, comparatively steep or gradual. In order to determine the depth of penetration, the point of inflection in the plot of the crosslinking density as a function of the depth of penetration is used.

An embodiment in which the crosslinked flexographic printing element is exposed to UV light having a wavelength of from 200 to 300 nm, i.e. UV-C light, has proven particularly useful for carrying out step (b′). Owing to the comparatively strong scattering of the short-wave light in the layer, the intensity of the UV-C radiation decreases substantially with increasing depth of penetration, so that effectively only the uppermost zone of the flexographic printing element is crosslinked.

Further details of process step (b′) are disclosed in the publication WO 02/49842, which is hereby incorporated by reference.

In process step (c), a printing relief is engraved into the crosslinked, relief-forming layer by means of a laser emitting from 3 000 to 12 000 nm. In this wavelength range, the elastomeric binders generally have sufficient absorption so that additional absorbers for laser radiation need not be used. CO₂ lasers (wavelength 10.6 μm) are particularly suitable. It is in principle also possible to use other laser types of comparable wavelength for engraving. The lasers may be operated either continuously or in the pulsed mode.

The relief-forming layer is removed or at least delaminated in those areas where it is exposed to a laser beam of sufficient intensity. The layer is preferably evaporated or thermally or oxidatively decomposed before melting, so that its decomposition products are removed from the layer in the form of hot gases, vapors, fumes or small particles.

The image information to be engraved with the laser can be transferred directly from the layout computer system to the laser apparatus.

Advantageously, relief elements in which the sidewalls of the elements are initially perpendicular and broaden only in the lower region are engraved. A good shoulder shape of the relief dots in combination with an increase in tonal value which is nevertheless low during printing with the printing plate obtained is achieved thereby. However, sidewalls of another form can also be engraved.

The depth of the elements to be engraved depends on the total thickness of the relief and on the type of elements to be engraved and is determined by a person skilled in the art according to the desired properties of the printing plate. The depth of the relief elements to be engraved is at least 0.03 mm, preferably 0.05 mm, the minimum depth between individual dots being mentioned here. Printing plates having relief heights which are too small are generally unsuitable for printing by means of the flexographic printing technique because the negative elements become filled with printing inks. Individual negative dots should usually have greater depths; for those of 0.2 mm diameter, a depth of at least 0.07 to 0.08 mm is usually advisable. In the case of areas which have been engraved away, a depth of more than 0.15 mm, preferably more than 0.4 mm, is advisable. The latter is of course possible only in the case of a correspondingly thick relief.

It is as a rule advantageous to keep decomposition products formed away from the surface of the flexographic printing element or the relief layer in the course of the laser engraving and as far as possible to remove them irreversibly. This measure completely or at least for the most part prevents degradation products on the relief surface from being able to combine with the relief surface again. For example, a suitable extraction apparatus which sucks away the resulting decomposition products, in particular aerosols, from the plate surface can be used. In a further embodiment, a gas or a gas mixture can be blown over the plate surface, the gas stream carrying the decomposition products with it. It is preferably an air or nitrogen stream.

The relief printing plate obtained can optionally be subsequently cleaned in a process step (d). The subsequent cleaning can be effected, for example, mechanically by simply brushing or rubbing the printing plate obtained. However, the surface of the printing plate can also be blasted by means of a gas jet, for example of compressed air. The higher the pressure or velocity of the gas jet, the better of course is the cleaning effect. In the case of excessively high pressures, the surface of the printing plate may however be damaged. Accordingly, a person skilled in the art will choose a compromise between the best possible cleaning and process reliability.

A liquid cleaning agent which substantially does not swell the relief layer is preferably used for the subsequent cleaning in order also to be able to remove polymer fragments completely. This is particularly advisable, for example, when food packagings for which particularly stringent requirements apply with respect to volatile components are to be printed using the flexographic printing plate.

The choice of a suitable cleaning agent depends on the composition of the relief layer. For the—more frequently occurring—case where the relief layer has components soluble in organic solvents, for example SBS or SIS block copolymers and monomers compatible therewith, water or predominantly aqueous cleaning agents are used. Aqueous cleaning agents substantially comprise water and optionally small amounts of alcohols and may contain assistants, for example surfactants, emulsifiers, dispersants or bases, to promote the cleaning process. Advantageously, emulsions of water, organic solvents and suitable assistants can also be used for the subsequent cleaning. The microemulsion detergents disclosed in WO 99/62723 and comprising water, alkyl esters of saturated or unsaturated fatty acids and surfactants have proven particularly advantageous. Mixtures which are usually used for developing conventional, water-developable flexographic printing plates may also be used.

The subsequent cleaning can be effected, for example, by simple immersion or spraying of the relief printing plate or may additionally be supported by mechanical means, for example by brushes or plush pads. Conventional washers for flexographic printing plates may also be used. The use of nonswelling cleaning agents does away with the need for time-consuming drying of the printing plate after the subsequent cleaning.

Of course, the photopolymerizable flexographic printing element used as a starting material for the process is usually produced on an industrial scale by a printing plate manufacturer, while the laser engraving (c) and any subsequent cleaning step are usually carried out by process engravers or by a printer.

There are several possibilities with regard to the steps (a), (b) and, if required (b′). These can be carried out by process engravers or a printer. The photochemical crosslinking can be carried out, for example, in commercial flexographic exposure units. UVC exposure units are also usually present in process engravers or printers.

However, the steps (a), (b) and, if required (b′) can of course also be carried out by the printing plate manufacturer himself so that a customer receives the material prepared for laser engraving.

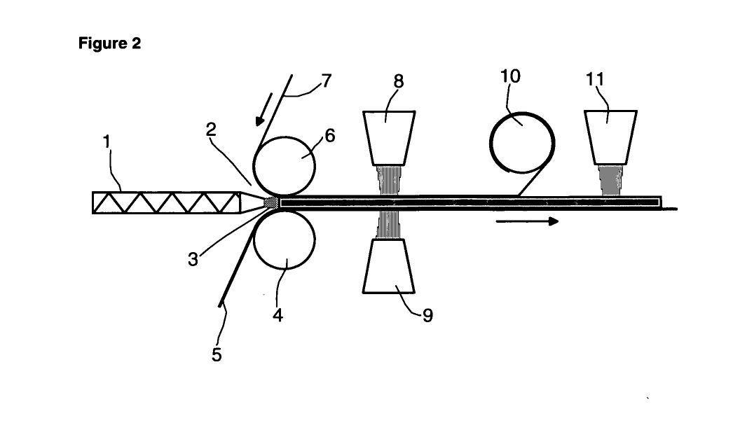

The continuous process shown in FIG. 1 has proved to be a preferred embodiment for this purpose: a thermoplastic elastomeric binder is used. The components of the relief-forming layer are melted in a known manner in an extruder (1) and mixed thoroughly with one another. The hot photopolymerizable material is discharged through a slot die (2) into the nip of a calender (3). The substrate film (5) is passed over a calender roll (4) and the protective element (7) is passed over the second calender roll (6) and the hot photopolymeric material is calendered between the two films. After passing through the calender, the photopolymerizable flexographic printing element is allowed to cool and then exposed to actinic light (UV-A) from the front by means of an exposure station (8) and optionally also from the back by means of a further exposure station (9) and is thus photochemically crosslinked. After the crosslinking station, the protective element can be peeled off. This can be effected, for example, by rolling onto a roller (10), as shown in FIG. 1. Optionally, exposure to UV-C (11) can then be effected. If no UV-C exposure is intended, the protective element can of course remain on the flexographic printing element.

The film position can also be interchanged, i.e. the substrate film can also be fed in over the upper calender roll (6) and the protective element over the lower calender roll (4). The positions of the exposure stations and any peeling apparatus (10) then change accordingly.

The novel process gives flexographic printing plates of substantially higher quality than those obtainable by means of the process described by U.S. Pat. No. 5,259,311. In the process described by U.S. Pat. No. 5,259,311, problems occur in particular in the fine screen area. A great deal of fused material forms in the course of the laser engraving and combines with the surface again and cannot be washed off even with organic solvents. By avoiding a double drying process, a great deal of time is saved. The exposure through the cover sheet leads to a particularly smooth layer surface and good ink transfer during printing. Particularly crisp edges are obtained as a result of the UV-C exposure.

The examples which follow illustrate the invention:

Experimental Section:

A three-beam CO₂ laser system of the type BDE 4131 (from STK) was used for the engraving experiments. The three laser beams had a power of 77, 166 and 151 W on the plate surface. The apparatus has a rotating drum. For engraving, the flexographic printing element is mounted on the drum and the latter is rotated. The speed at the surface of the drum was 7 m/s in all experiments and the advance of the laser beams transversely to the direction of rotation was 20 μm per revolution.

A test pattern of different elements comprising lines, positive dots, negative dots, letters (capital “A”), numbers (“3%”) and various screens was engraved.

The quality of the print relief was evaluated on the basis of the following parameters:
the visual appearance of the 3% screen area (ideally round dots)
the general appearance
the occurrence of melt edges
the gravure depth (measured at the base of the capital “A”) as a difference in height between a completely removed area and the plate surface
diameter of a 200 μm positive dot
diameter of a 200 μm negative dot
intermediate depth in the 200 μm negative dot
width of a 20 μm negative line which is parallel to the laser direction
width of a 20 μm negative line which is transverse to the laser direction
   Materials Used:

A commercial, photopolymerizable flexographic printing element having a conventional release layer and a PET cover sheet was used for comparative experiments 3, 4 and 5 (nyloflex® ART, BASF Drucksysteme GmbH). In this element, the adhesion between the release layer and the photopolymerizable layer is greater than that between the cover sheet and the release layer. This is produced in a conventional manner by extrusion and calendering of the hot, photopolymerizable material between the substrate film and the cover element.

A flexographic printing element whose photopolymerizable layer corresponded to the nyloflex® ART was used for experiments 1 and 2 and comparative experiments 1 and 2. Instead of the conventional release layer and the conventional cover sheet, the flexographic printing element had only a novel protective element. The protective element consisted of a PET film (Lumirror X 43) coated with the polyamide Macromelt® 6900 (from Henkel). The adhesion between the film and the nontacky coating was greater than the adhesion between the additional coating and the PET film so that, after the exposure, the protective element could be peeled off as a whole, i.e. including the coating, from the relief-forming layer.

### EXAMPLE 1

The novel flexographic printing element described above was used.

The flexographic printing element was crosslinked through the protective element for 15 minutes using UV-A radiation (FIII exposure unit). The crosslinking was not complete and unconverted ethylenically unsaturated monomers still remained in the layer.

After the exposure to UV-A, the protective element was peeled off. No residues of the protective element at all remained on the photopolymerizable layer. The nontacky layer of the protective element remained completely adhering to the film.

The relief-forming layer was then exposed from the top for 15 minutes to UV-C light. This increased the crosslinking in the uppermost part of the layer, and the relief-forming layer was thus hardened superficially.

The test pattern described above was then engraved into the crosslinked layer using the laser system described above.

The engraved relief was evaluated. The results are summarized in table 1. A picture of the relief is shown in FIG. 1.

### EXAMPLE 2

The procedure was as in example 1, except that the additional exposure step with UV-C was dispensed with.

The engraved relief was evaluated. The results are summarized in table 1. A picture of the relief is shown in FIG. 1.

Comparative Experiment 1:

The novel flexographic printing element was used and the procedure was as in experiment 1, except that the protective element was removed before the exposure to UV-A radiation. The results are summarized in table 1. A picture of the relief is shown in FIG. 1.

Comparative Experiment 2:

The novel flexographic printing element was used and the procedure was as in experiment 1, except that the protective element was removed before the exposure to UV-A radiation and no postexposure to UV-C was carried out. The results are summarized in table 1. A picture of the relief is shown in FIG. 1.

Comparative Experiment 3:

The commercial flexographic printing element nyloflex® ART was used.

The cover sheet was peeled off from the flexographic printing element, the release layer remaining on the photopolymerizable layer. The flexographic printing element was crosslinked through the release layer for 15 minutes using UV-A radiation.

The test pattern described above was then engraved into the crosslinked layer using the laser system described above.

The engraved relief was evaluated. The results are summarized in table 1. A picture of the relief is shown in FIG. 1.

Comparative Experiment 4:

Procedure according to U.S. Pat. No. 5,259,311.

The procedure was as in comparative experiment 3 except that, after the crosslinking with UV-A radiation, the release layer was removed by means of the flexographic plate developer nylosolv®II (BASF Drucksysteme GmbH). The crosslinked flexographic printing element was dried for 15 minutes at 65° C. and then engraved using the laser system.

The engraved relief was evaluated. The results are summarized in table 1. A picture of the relief is shown in FIG. 1.

Comparative Experiment 5:

Procedure as in U.S. Pat. No. 5,259,311.

The procedure was as in comparative experiment 4, except that drying was effected for 120 minutes at 65° C.

The engraved relief was evaluated. The results are summarized in table 1. A picture of the relief is shown in FIG. 1.

TABLE 1
Results of examples and comparative examples

| | Example No. | | | | | | |
|---|---|---|---|---|---|---|---|
| | 1 | 2 | C1 | C2 | C3 | C4 | C5 |
| Comment | According to | According to | Protective | Protective | Conventional | Conventional | Conventional |
| | the invention | the invention | element | element | flexographic | flexographic | flexographic |
| | Exposure | Exposure | peeled off | peeled off | printing element, | printing element, | printing element, |
| | through | through | before | before | cover sheet | cover sheet peeled | cover sheet peeled |
| | protective | protective | exposure | exposure | peeled off, | off, release layer | off, release layer |
| | element | element | | | release layer | washed off with | washed off with |
| | | | | | still present | solvent before | solvent before |
| | | | | | | laser engraving, | laser engraving, |
| | | | | | | drying for 15 min | drying for 120 min |
| UV-C crosslinking | yes | no | yes | no | no | no | No |
| of the surface | | | | | | | |

Laser engraving result

| | | | | | | | | |
|---|---|---|---|---|---|---|---|---|
| Appearance of the | | round | round | round | oval | round | round | Round |
| 3% screen | | | | | | | | |
| Melt edges | | no | no | yes | yes | yes | no | No |
| Gravure depth of | [μm] | 510 | 455 | 509 | 500 | 472 | 528 | 528 |
| capital “A” | | | | | | | | |
| 200 μm dot | [μm] | 179 | 189 | 179 | 200 | 155 | 178 | 178 |
| diameter top | | | | | | | | |
| 200 μm negative | [μm] | 245 | 234 | 245 | 250 | 252 | 246 | 245 |
| dot, diameter | | | | | | | | |
| 200 μm negative | [μm] | 76 | 56 | 86 | 62 | 74 | 96 | 94 |
| dot, depth | | | | | | | | |
| Width of 20 μm | [μm] | 47 | 40 | 50 | 48 | 65 | 52 | 51 |
| lines (longitudinal) | | | | | | | | |
| Width of 20 μm | [μm] | 41 | 32 | 56 | — | 43 | 46 | 44 |
| lines (transverse) | | | | | | | | |

[image]

[image]

The experiments show that flexographic printing plates of high quality are obtained using the novel process.

A flexographic printing plate which gives a clean print relief with crisp edges and has no melt edges at all is obtained in experiments 1 and 2 (see FIG. 1).

If, on the other hand, the protective element is peeled off in the case of the novel flexographic printing element and otherwise the same procedure is used, flexographic printing plates obtained have substantial melt edges (comparative experiments 1 and 2 in FIG. 1). In comparative experiment 2, it is moreover evident that the 3% screen is no longer formed as well as in the novel examples. The shape of the dots is no longer exactly round but oval.

On engraving a conventional flexographic printing element, i.e. through a release layer remaining on the relief-forming layer (comparative experiment 3, FIG. 1), a flexographic printing plate having melt edges is obtained. If the release layer is removed using a flexographic developer before the laser engraving, as described by U.S. Pat. No. 5,259,311, the occurrence of melt edges can be avoided (comparative experiments 4 and 5, FIG. 1). The sensitivity even increases slightly as a result of the washing out. Disadvantageously, however, the edges of the image subjects become substantially less crisp as a result of the treatment with solvent. This is very clearly evident from the script “3%”, which appears blurred after treatment with solvent. This effect cannot be avoided even by prolonged drying. The flexographic printing element thus undergoes an irreversible adverse change as a result of treatment with solvent before the laser engraving.

The novel process and the novel flexographic printing element thus lead to a significant improvement in comparison with the process disclosed by U.S. Pat. No. 5,259,311.

1-11. (canceled)

12. A process for the production of flexographic printing plates by means of laser engraving, in which the starting material used is a photopolymerizable flexographic printing element at least comprising, arranged one on top of the other,
a dimensionally stable substrate,
a photopolymerizable, relief-forming layer having a thickness of at least 0.3 mm, at least comprising an elastomeric binder, an ethylenically unsaturated monomer and a photoinitiator, and
a protective element substantially transparent to actinic light,
wherein the process comprises—in this sequence—the following steps:
(a) crosslinking of the relief-forming layer in the total volume of the layer by exposure to actinic light through the protective element,
(b) removal of the protective element and
(c) engraving of a print relief into the crosslinked relief-forming layer with the aid of a laser emitting from 3 000 to 12 000 nm, the height of the relief elements to be engraved with the laser being at least 0.03 mm,
and the protective element is a film which has been provided with a nontacky treatment or coating on the side facing the relief-forming layer and which is applied directly to the relief-forming layer, the adhesion between the protective element and the relief-forming layer being adjusted so that the protective element can be peeled off the crosslinked, relief-forming layer after process step (a), and wherein the actinic light is UV-A radiation having a wavelength of from about 320 to 400 nm and/or UV-A/VIS radiation having a wavelength of from about 320 to about 700 nm.

13. A process as claimed in claim 12, wherein the protective element comprises a nontacky coating.

14. A process as claimed in claim 13, wherein the nontacky layer substantially comprises a polyamide, and the elastomeric binder in the relief-forming layer is a thermoplastic elastomeric block copolymer of the styrene/butadiene type.

15. A process as claimed in claim 12, which additionally comprises a subsequent cleaning step (d).

16. A process as claimed in claim 12, wherein decomposition products formed in step (c) are sucked away.

17. A process as claimed in claim 12, wherein, after the removal of the protective film (b), the crosslinked relief-forming layer is crosslinked in a subsequent process step (b′) to a limited depth of penetration, viewed from the surface, beyond the extent of the crosslinking density produced by step (a).

18. A process as claimed in claim 17, wherein the depth of penetration to which additional crosslinking is effected in step (b′) is from 5 to 200 μm.

19. A process as claimed in claim 17, wherein the surface crosslinking step (b′) is carried out using UV light having a wavelength of from 200 to 300 nm.

20. A photopolymerizable flexographic printing element, at least comprising, arranged one on top of the other,
a dimensionally stable substrate,
a photopolymerizable, relief-forming layer having a thickness of at least 0.3 mm, at least comprising an elastomeric binder, an ethylenically unsaturated monomer and a photoinitiator, and
a protective element substantially transparent to actinic light,
wherein the protective element is a film which has been provided with a nontacky treatment or coating on the side facing the relief-forming layer and which is applied directly to the relief-forming layer, the adhesion between the protective element and the relief-forming layer being adjusted so that the protective element can be peeled off the crosslinked relief-forming layer after exposure to actinic light through the protective element, and wherein the actinic light is UV-A radiation having a wavelength of from about 320 to 400 nm and/or UV-A/VIS radiation having a wavelength of from about 320 to about 700 nm.

21. A flexographic printing element as claimed in claim 20, wherein the protective element comprises a nontacky coating.

21. A flexographic printing element as claimed in claim 21, wherein the nontacky layer substantially comprises polyamide.
